(19) United States
(12) Patent Application Publication
(10) Pub. No.: US 2005/0041035 A1
(43) Pub. Date: Feb. 24, 2005

(54) Electronic apparatus having a communication function and an image pickup function, and image display method and program

(75) Inventors: Shoichi Nagatomo, Fussa-shi (JP); Shiori Sonoyama, Machida-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/922,279

(22) Filed: Aug. 19, 2004

(30) Foreign Application Priority Data
Aug. 21, 2003 (JP) 2003-297768
Feb. 27, 2004 (JP) 2004-053684

(51) Int. Cl. G09G 5/02; G09G 5/36; G09G 5/399; G06T 1/60

(52) U.S. Cl. 345/601; 345/602; 345/545; 345/539; 345/530

(57) ABSTRACT

A controller creates a file of image data picked up, downloaded by a communication function, or annexed to a received mail and stores it in a RAM. When an album mode is selected, the controller creates a thumbnail(s) of the image(s) file stored in the RAM and stores them on an album management table. The controller then develops the thumbnails in a display buffer according to the content of the album management table. When the controller receives an image of an image file with copyright protection information, it creates thumbnail data from the image of the received image file. Then, the controller also develops this thumbnail data in the display buffer. The controller then simultaneously displays the thumbnails developed in the display buffer on a main display unit such that sources of the thumbnails can be recognized at a glance. When the album mode ends, the display buffer is then cleared.

### FIELD OF THE INVENTION

The present invention relates to electronic apparatus that display image data downloaded from an external network such as the Internet, using a communication function, image data affixed to a message such as an electronic mail received, and image data obtained using an image pickup function. The present invention also relates to image display methods and programs for such image data.

### BACKGROUND ART

As described in Japanese patent publication 2000-232595, prior-art digital cameras store an image in a file format (or Exif) according to DCF standards. When an album mode is started up, thumbnail data set and stored in the image file are read out and the corresponding thumbnails are simultaneously displayed so as to be recognized at a glance. Also, when the album mode is started up in an electronic apparatus represented by a mobile telephone with a camera, real image data and thumbnail data stored therein are re-sized and displayed simultaneously as images.

With the mobile telephones with a camera, however, images (inclusive of copyrighted images) downloaded over the Internet are not file formatted according to the DCF standards. Copyrighted images are inhibited as a whole from being processed and transferred to external devices. Therefore, in the prior art techniques when picked-up images and downloaded images stored in a mixed state on a recording medium (flash ROM) are displayed in a mixed state in the album mode, they cannot be distinguished from each other at a glance unless the downloaded images contain thumbnails.

With the mobile telephone with a camera, the volume of image data picked up tends to increase as the number of pixels of the camera increases. Thus, a memory of the mobile telephone and an external memory are compelled to store a limited number of files of picked-up image data. Therefore, even though the mobile telephone has a camera function, the user cannot pick up a desired image when the user desires to do so if it has no sufficient memory capacity. In order to overcome this problem, a technique has been proposed that sends the picked-up image data to a database (server) on a network such as the Internet, using a communications function, and then stores the data in the database. Also, in this case as described above, when the picked-up images and downloaded images stored in the mixed state on the recording medium (flash ROM) as well as the images stored in the database on the network are displayed in a mixed state in the album mode, they cannot be distinguished from each other at a glance unless the downloaded images contain thumbnails.

### SUMMARY OF THE INVENTION

It is therefore an object of the present invention to provide a electronic apparatus and display method that allows a picked-up image or downloaded image to be confirmed at a glance and also allows storage devices in which the respective picked-up images are stored to be confirmed at a glance.

In order to achieve the above object, according to one aspect of the present invention there is provided an electronic apparatus comprising: an image pickup device;
a first thumbnail-creating unit that creates a thumbnail of an image picked up by the image pickup device;
a storage unit that stores in a predetermined file form the thumbnail created by the first thumbnail creating unit along with the image picked up by the image pickup device;
a communication unit;
a reception unit that receives an image file from a network outside the electronic apparatus, using the communication unit;
a storage control unit that stores in the storage unit the image file received from the reception unit;
a display unit;
a command unit that gives the display unit a command to simultaneously display the images stored in the storage unit;
a second thumbnail creating unit, responsive to the command from the command unit, for creating a thumbnail from the image file received by the reception unit; and
a first display control unit that simultaneously displays the thumbnails created by the first and second thumbnail creating units on the display unit.

According to another aspect of the present invention, there is also provided an image display method in a electronic apparatus comprising an image pickup device, a communications unit and a display unit, the method comprising the steps of:
creating a thumbnail of an image picked up by the image pickup unit;
storing in a memory in a predetermined file form the thumbnail created in the thumbnail creating step along with the image picked up by the image pickup device;
receiving an image file containing an image from a network outside the electronic apparatus, using the communication unit;
storing in the memory the image file received in the receiving step;
giving the display unit a command to simultaneously display the images stored in the memory;
responsive to the command, creating a thumbnail of the image contained in the image file received in the receiving step; and
simultaneously displaying on the display unit the thumbnails created in both the creating steps.

According to still another aspect of the present invention, there is provided an image display program for causing a computer with an image pickup device, a communications unit and a display unit to perform the functions of:
creating a thumbnail of an image picked up by the image pickup unit;
storing in a memory in a predetermined file form the thumbnail created by the thumbnail creating function along with the image picked up by the image pickup device;
receiving an image file containing an image from a network outside the computer, using the communication unit;
storing the image file received by the receiving function in the memory;
giving the display unit a command to simultaneously display the images stored in the memory;
responsive to the command, creating a thumbnail of the image contained in the image file received by the receiving function; and
simultaneously displaying on the display unit the thumbnails created by both the creating functions.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 illustrates a structure of a mobile telephone communications system as a first embodiment of the present invention;

FIG. 2 is an appearance view of a mobile telephone (i.e., a front view and a back view in an open state) in the embodiment;

FIG. 3 is a block diagram indicative of the structure of the mobile telephone;

FIG. 4 schematically illustrates image data stored in a RAM of the mobile telephone;

FIG. 5 schematically illustrates an album management table of the mobile telephone;

FIG. 6 is a flowchart illustrating operation of the embodiment in an album mode;

FIG. 7 schematically illustrates a display on a main display screen in the album mode;

FIG. 8 is a block diagram indicative of the structure of the mobile telephone in a second embodiment;

FIG. 9 schematically illustrates image data stored in the RAM of the mobile telephone in the second embodiment;

FIG. 10 is a flowchart illustrating operation of the second embodiment in an image pickup mode;

FIG. 11 is a flowchart illustrating operation of the second embodiment in an album mode;

FIG. 12 is a flowchart continued to that of FIG. 11;

FIG. 13 is a flowchart illustrating another operation of the second embodiment in the album mode;

FIG. 14 schematically illustrates a display on the main display screen of the second embodiment in the album mode;

FIG. 15 schematically illustrates another display on the main display screen of the second embodiment in the album mode;

FIG. 16 schematically illustrates still another display on the main display screen of the second embodiment in the album mode.

### DETAILED DESCRIPTION OF THE INVENTION

Embodiment of the present invention applied to the mobile telephone will be described with reference to the accompanying drawings.

(First Embodiment)

(1-1) Structure

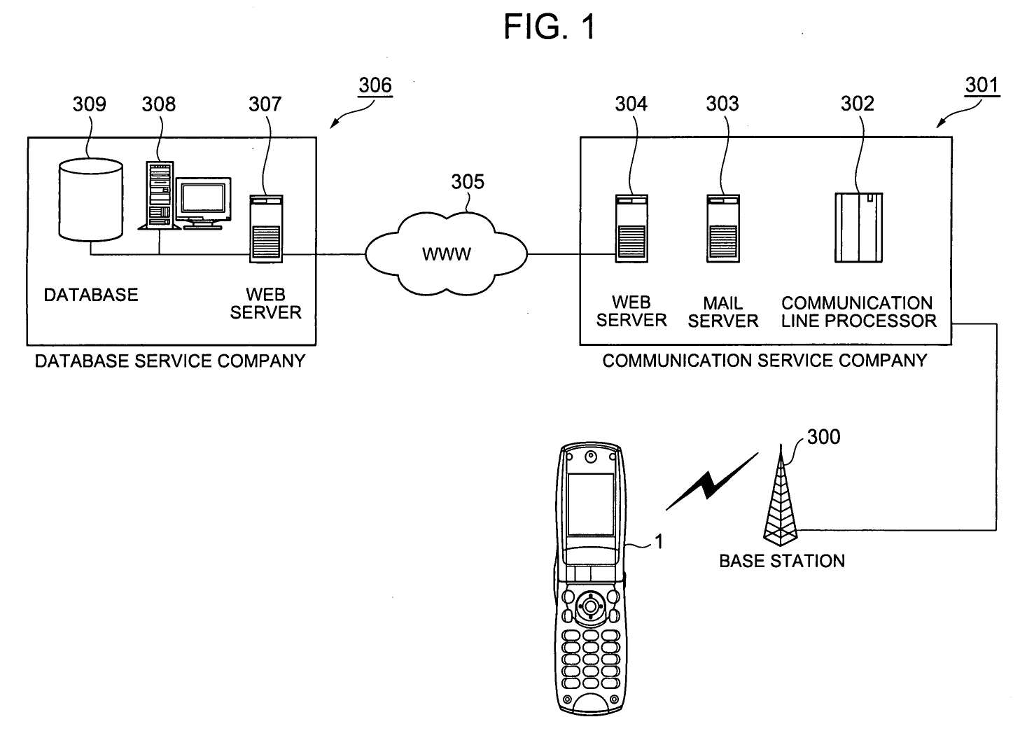

A first embodiment of the present invention will be described. FIG. 1 illustrates a structure of a mobile telephone/communications system according to the present invention. In FIG. 1, a mobile telephone 1 has a telephone function and an image sending/receiving function according to a frequency band and a radio communications protocol employed in a mobile telephone communications service. A radio base station 300 connects the mobile telephone 1 to a specified one 301 of communications service providers (including the Internet provider) that provides the mobile telephone 1 with services by subscription.

The communications service provider 301 comprises a communications line processor 302 for mobile telephone services provided as a main service, a system (web server 308) for connection to a WWW 305 to be described later in more detail, and a mail system (mail server 303). It also has a function of connecting the mobile telephone 1 to the WWW 305 with the radio base station 300 as an access point AP. The database service company 306 comprises a system (web server 307) for connection to the WWW 305, a management server 308 and a database 309 that stores a HTML file and image files uploaded from subscribers, and multimedia data.

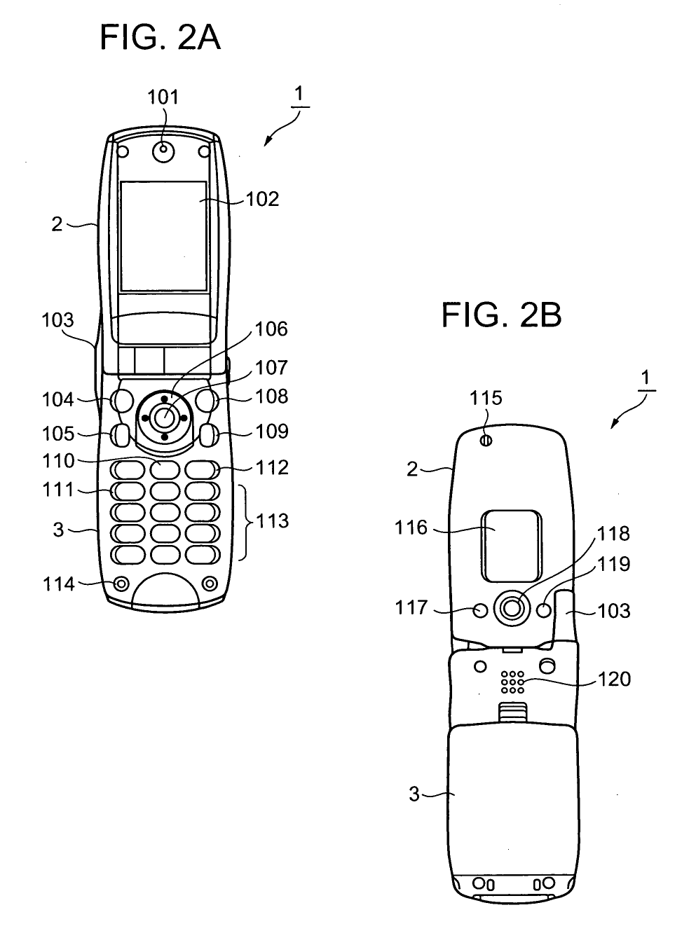

FIG. 2 shows an appearance of the mobile telephone 1 (a front view and a back view in an open state). The mobile telephone 1 has a folding structure of a cover 2 and a body 3. A speaker 10 is provided on a front of the cover 2 for providing a voice output. A main display unit 102 is of a color liquid crystal type that has a QVGA resolution and is adapted to display a picked-up image or an image downloaded via the WWW 305. An extensible antenna 103 is provided on a back of the body 3.

A camera key 104 is used to command the mobile telephone 1 to shift to an image pickup mode and start up the image pickup unit. A mail key 105 is used to command the mobile telephone 1 to shift to a mail mode and load a mail program. A cross key 106 is used to command the mobile telephone 1 to move a cursor and a focus (selection). A decision key 107 is used to decide a selected mode. An address key 108 is used to display address notebook data. A net connection key 109 is used for connection to the Internet. A clear key 110 is used to cancel a selection or another. An on hook key 111 is used for line connection. An off hook key 112 is used to cut off a line connection. An alphanumeric key unit 113 is used to input characters and/or dial numbers.

A microphone 114 is provided on the front of the body 3 at a lower position for giving a voice input to the microphone in telephone call. A recording microphone 115 is used to input a voice memo/a voice in animation pickup. A subdisplay unit 116 is provided on a back of the cover and is used to display a date and time, report an incoming call and an incoming mail, and also used as an auxiliary display screen when a still image/moving image is picked up with the mobile telephone 1 closed. A reporting LED 117 is used to report an incoming call/mail.

An image pickup lens 118 is provided on the back of the cover 2 below the subdisplay unit 116 to pick up still or moving images. A flash LED 119 is lighted up to pick up a still or moving image, thereby preventing insufficient exposure. A reporting speaker 120 reports an incoming call or emergency. It is disposed on the back of the body 3 such that the user can hear the reporting sound even when the cover 2 is closed against the body 3.

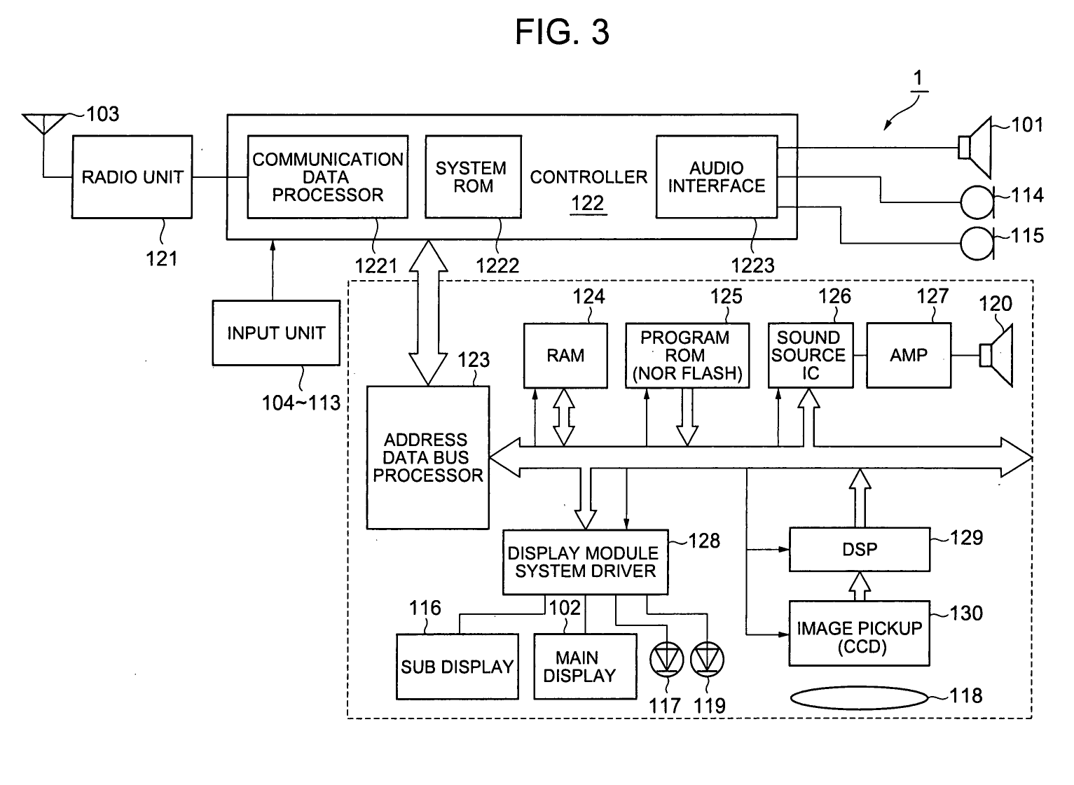

FIG. 3 is a block diagram of the mobile telephone 1. In FIG. 3, a radio transceiver 121 sends/receives voice and other data (mail data) wirelessly via the antenna 103, and modulates/demodulates data. That is, it performs communications processes including modulation/demodulation in a PSK system, and a terminal authentication process in a CDMA system.

A controller 122 controls the mobile telephone, inclusive of WWW connection control. A communication data processor 1221 comprises a CLEP system vocoder and a voice decoding processor, a packet data generator, and a packet data restoring circuit, and performs data processing in accordance with a communications protocol. A system ROM 1222 has stored a basic system program to control the mobile telephone. An audio interface 1223 receives a voice signal processed in the communication data processor 1221 and outputs it as a voice from the speaker 101; receives a voice from the microphone 114 or recording microphone 115, converts it to a voice signal, and then delivers this signal to the communication data processor 1221; and receives a voice signal from the microphone 114 or 115 and delivers it to the speaker 101 for outputting purposes.

An address data bus processor 123 controls and manages timing of inputting/outputting data to/from peripheral circuits (shown in a surrounding broken line). A RAM 124 stores various data such as address notebook data, mail data, etc., produced in the mobile telephone. A program ROM 125 comprises a rewritable flash ROM that has stored a program that compresses and encodes in the JPEG form image data encoded by a DSP 129 to be described later in more detail and that produces a file form (Exif) according to DCF standards; a program that encodes an image file in the JPEG form, produces real image data and thumbnail data, if any, and outputs them to a display buffer of a display module system driver 128; and various other application programs.

The display module system driver 128 drives a subdisplay unit 116, a main display 102 unit, and LEDs 117 and 119. A sound source IC 126 produces an incoming call ring. An amplifier 127 amplifies a voice signal from the sound source IC 126, and the speaker 120 lets off a corresponding sound. An image pickup device 130 comprises a CCD or CMOS that picks up as a color image an image focused by the image pickup lens 118. The DSP 129 encodes this picked-up image.

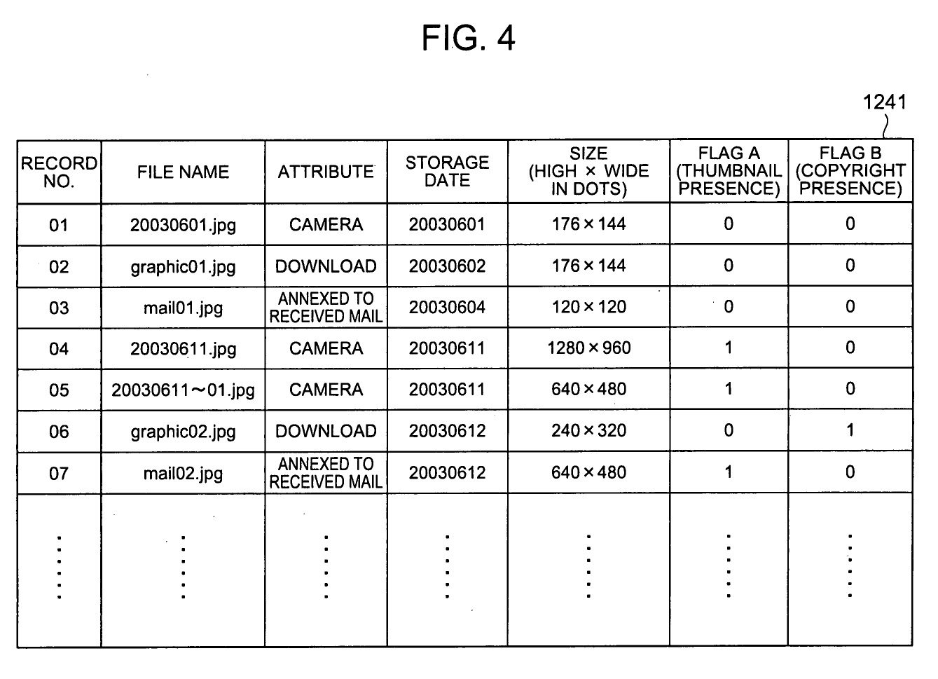

FIG. 4 schematically illustrates a image file table 1241 stored in the RAM 124 of the mobile telephone in this embodiment. The table 1241 is managed according to record number. Each record comprises a field of a file name, an attribute, a storage date, a size, and flags A and B. The file name is given uniquely to its image file. The attribute indicates a source from which the image file is obtained. The attribute “camera” indicates an image file that contains real image data picked up by a camera (or image pickup function) provided in the mobile telephone. The attribute “download” indicates an image file downloaded from the WWW 305. The attribute “annexed to received mail” indicates an image file annexed to a received mail.

The storage date and time indicates a date and time when the image file was stored in memory. The size indicates a size (high X wide in dots) of an image to be displayed on the main display unit based on the real image data in the image file. The flag A indicates the presence of thumbnail data in the image file; i.e., “0” and “1” indicate absence and presence, respectively. When the size of a real image based on the real image data is large, a corresponding thumbnail is usually created beforehand when the image file is created. The flag B indicates the presence of copyright protection information; i.e., “0” and “1” indicate absence and presence, respectively. Generally, an image file downloaded from the Internet has copyright protection information that inhibits copying and a secondary use of the image file without the copyright holder's permission.

For example, image files with record numbers 1-3 contain thumbnails. Image files with record numbers 4, 5 and 7 had already contained thumbnails when they were obtained, and have stored the thumbnail data and the real image data therein. An image file with record number 6 contains copyright protection information. From this image file, thumbnail data can be created and a corresponding thumbnail based on the thumbnail data can be displayed, but after this the thumbnail (data) must be cleared.

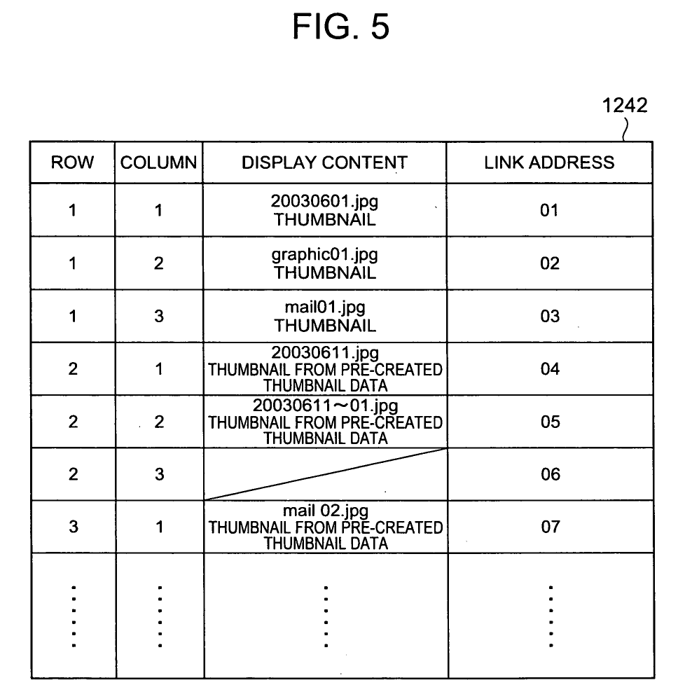

FIG. 5 schematically illustrates an album management table 1242 of the mobile telephone of this embodiment. The management table 1242 is created from the data of FIG. 4. In this embodiment, in the album mode the album management table 1242 is referred to, its thumbnail data is developed in the display buffer of the display module system driver 128 and corresponding thumbnails based on the thumbnail data are displayed simultaneously on the main display unit 102. The album management table 1242 has stored the position (row and column) of display of each image, the content (actually displayed thumbnail) of display at that position, and a link address indicative of the record number of an image file. When it is known by referring to the flag A that thumbnail data is stored, the thumbnail to be displayed becomes based on the thumbnail data. If no thumbnail data is stored, the thumbnail to be displayed comprises a reduced-sized real image. When the flag B indicates that copyright protection information is set, thumbnails are not held as the contents to be displayed, but created from the real image data when they are displayed simultaneously.

(1-2) Operation

Operation of the mobile telephone of the first embodiment will be described next.

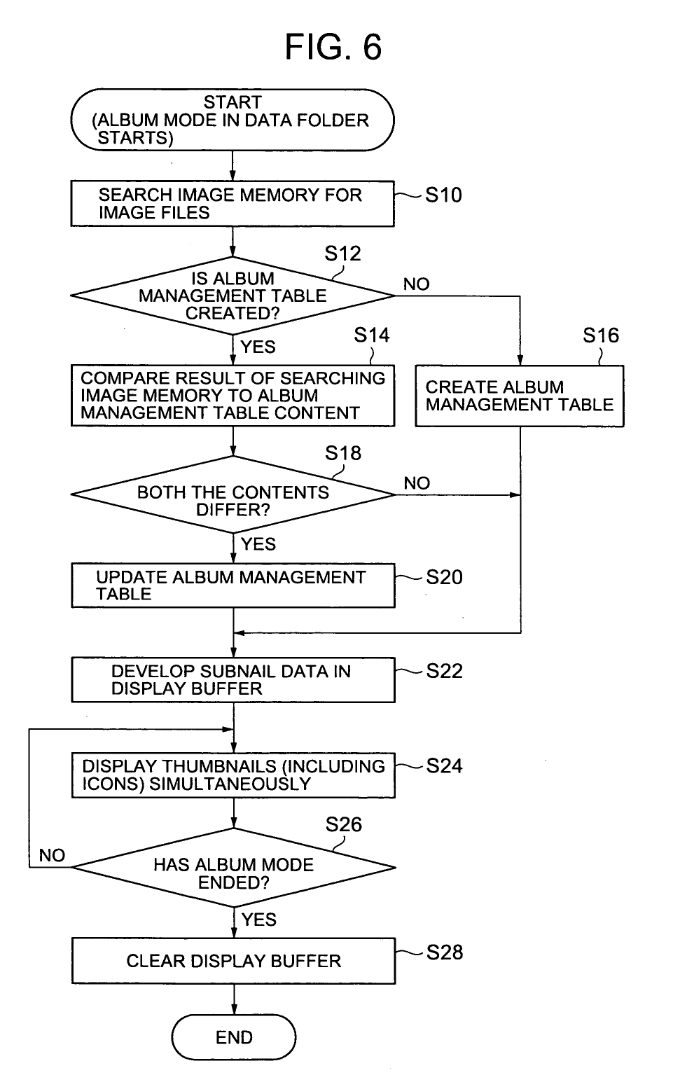

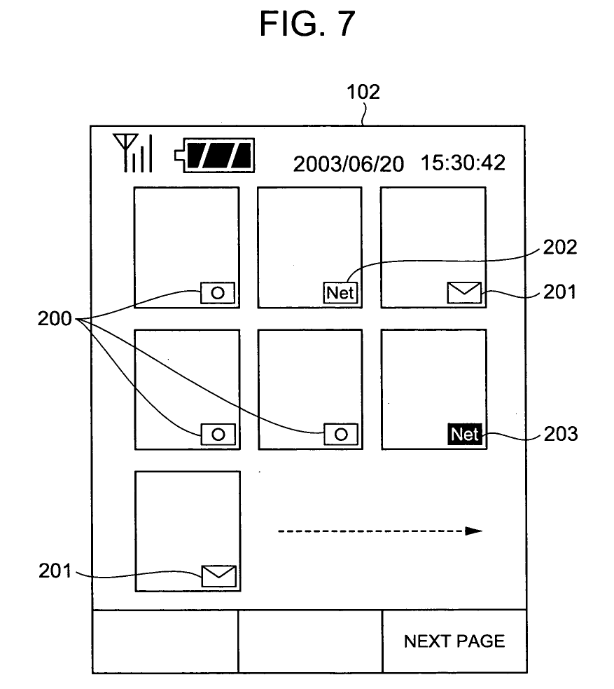

FIG. 6 is a flowchart of explaining operation of the mobile telephone in an album mode of a data folder. FIG. 7 schematically illustrates a display of the main display unit 102 in the album mode.

First, when the album mode is selected by the user in the data folder, the RAM 124 is searched for image files (S10) and it is determined whether or not the album management table 1242 (FIG. 5) has been created (S12).

If the respective image files and the created album management table 1242 are found, each of the image files is then compared to the content of the album management table 1242 (S14). Then, it is determined whether or not both are different (S18).

If both are different, the content of the album management table 1242 is updated with a result of searching the RAM 124 (S20). More particularly, a display (row and column) position on the main display 102 for a prospective thumbnail for each of the image files different from the content of the album management table 1242 is determined, corresponding thumbnail data, if any, contained in that image file or corresponding thumbnail data created from a real image data contained in that image file if no original thumbnail data is contained in that image file, as indicated by the flag A, is used, thereby updating the content of the album management table 1242. The thumbnail data corresponding to the thumbnail to be displayed is then developed in the display buffer in accordance with the updated content of the album management table 1242 (S22). If both are the same in content, the thumbnail data to be displayed is developed in the display buffer in accordance with the content of the album management table 1242 (S22). When it is known that no album management table 1242 has been created as the result of searching for the RAM 124, an album management table 1242 is created in accordance with the result of searching (S16). More particularly, display (row and column) positions of thumbnails for the image files stored in the RAM 124 on the main display 102 are sequentially determined in order of record number. Thumbnails are then created from the thumbnail data or real image data in accordance with the presence of the thumbnails indicated by the flag A, thereby creating an album management table 1242. Then, thumbnail data corresponding to the thumbnails to be displayed are developed in the display buffer in accordance with the content of the album management table 1242 (S22).

The content of an image to be displayed at a row “2” and column and “3” position on the main display unit 102 is indicated by a slash on the album management table 1242, which means containing image data “graphic 02.jpg” with copyright protection information downloaded from the Internet. Thus, when thumbnail data for that image data is developed in the display buffer, real image data in the corresponding image file is searched for in the RAM 124 in accordance with its link address “06” and then changed so as to provide thumbnail data. That is, each time real image data with copyright protection information is found by search, thumbnail data is created from the real image data and developed in the display buffer to display a corresponding thumbnail.

As shown in FIG. 7, the respective thumbnails (shown simply by rectangles) based on the thumbnail data developed in the display buffer are displayed simultaneously on the main display unit 102 (S24). At this time, an icon indicative of an attribute of each image file (or a source of the image file obtained) is displayed at a predetermined position (for example, a lower right end position in FIG. 7 in this example) on the displayed thumbnail. An icon 200 indicates “camera”; an icon 201 “received mail”; an icon 202 “downloaded (image data without copyright protection information)”; and an icon 203 “downloaded (image data with copyright protection information)”.

It is then determined whether or not the album mode has ended (S26). If the album mode has not ended, the control returns to step S24 in which the album mode continues. If the album mode has ended, the display buffer is cleared (S28). Thus, no thumbnail data of “graphic 02.jpg) with copyright protection information downloaded from the Internet remains.

While in the embodiment the thumbnail versions of the picked-up images and the images downloaded from the Internet are displayed simultaneously in a mixed state, both groups of the thumbnail versions may be displayed alternately in units of a page in a discriminating manner.

While in the embodiment the sources of the thumbnails of the picked up and downloaded images are simultaneously displayed on the display screen so as to be discriminated by their respective icons, the frames for the respective thumbnails may be displayed in different colors for discriminated purposes.

(Second Embodiment)

A second embodiment of the present invention will be described. In the second embodiment, an image file of image data picked up can be stored in one or more selected ones of internal and external memories as well as the database 309 of the database service company 306 of FIG. 1. In addition, it is arranged that when thumbnails of image files based on the image data picked up and thumbnails of image files downloaded from the WWW 305 or the like are displayed simultaneously in a mixed state, those of the internal and external memories as well as the database provided on the external network such as the WWW 305 or the like that have stored such image files can be confirmed at a glance.

(2-1) Structure

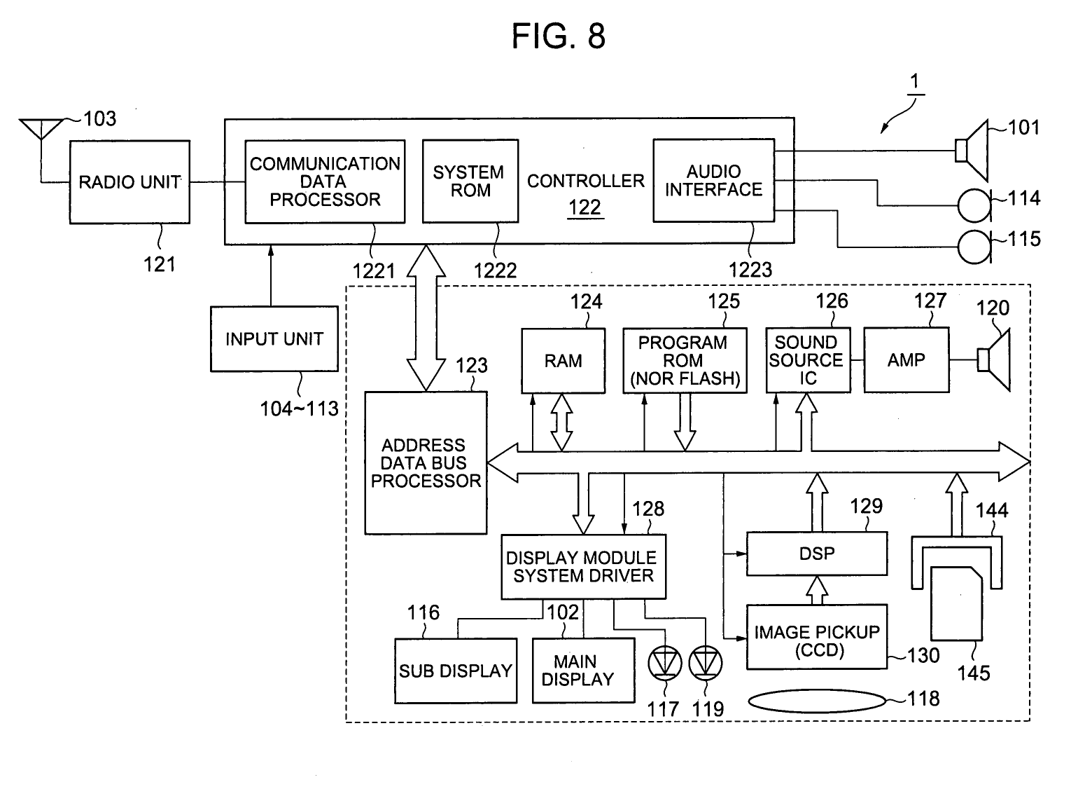

FIG. 8 is a block diagram of a mobile telephone with a camera as a second embodiment of the invention. The same reference numerals are used to denote parts of FIG. 8 similar to those of FIG. 3 and further description of the similar parts will be omitted. In FIG. 8, a connector 144 is adapted to receive thereon an external recording medium such as, for example, a mini SD card 145. The recording medium 145 records an image file based on image data picked up as user data. In the mobile telephone with a camera in this embodiment, an image file based on the image data picked up is adapted to be sent over the WWW 305 to the database company 306 via the communication data processor 1221, thereby uploading and storing the file on the database 309.

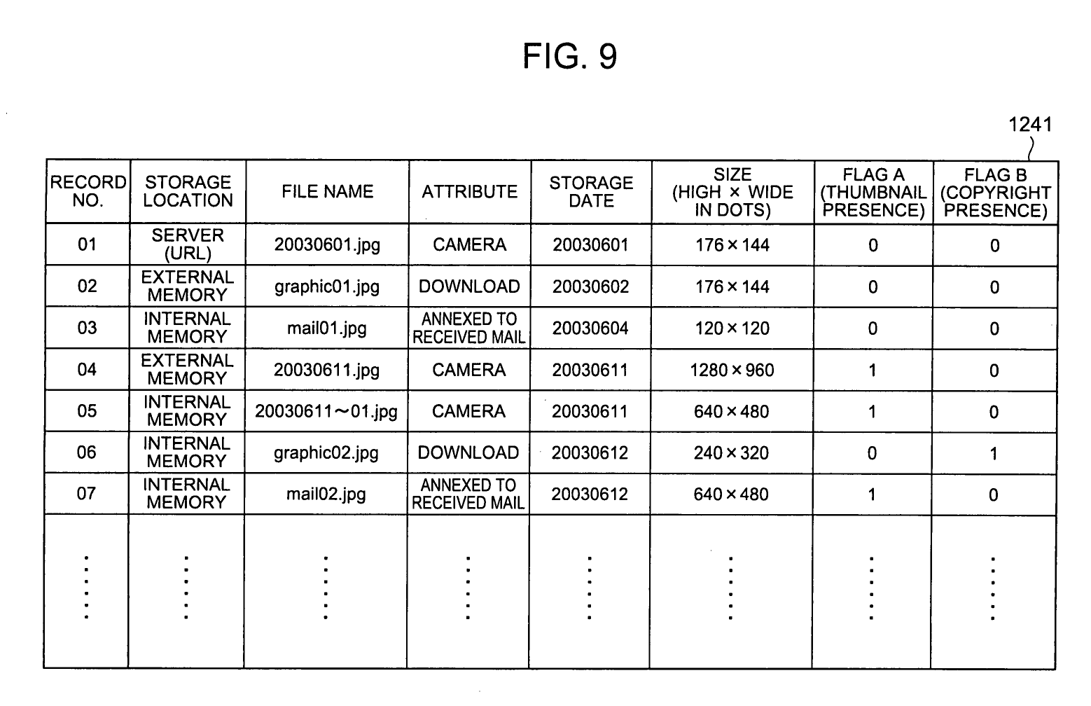

FIG. 9 schematically illustrates an image file table 1241 stored in the RAM 124 of the mobile telephone in the second embodiment. The table 1241 additionally has information indicative of locations at which the image files are stored compared to the table of the first embodiment. Such information includes a URL indicative of a server such as, for example, the database 309, and recognizable information indicative of the internal memory (RAM 124) if the image data is stored on this memory, or the external memory (external recording medium 145) if the image data is stored on this memory. The album management table 1242 of this embodiment is similar to that of the first embodiment, and further description will be omitted.

(2-2) Operation

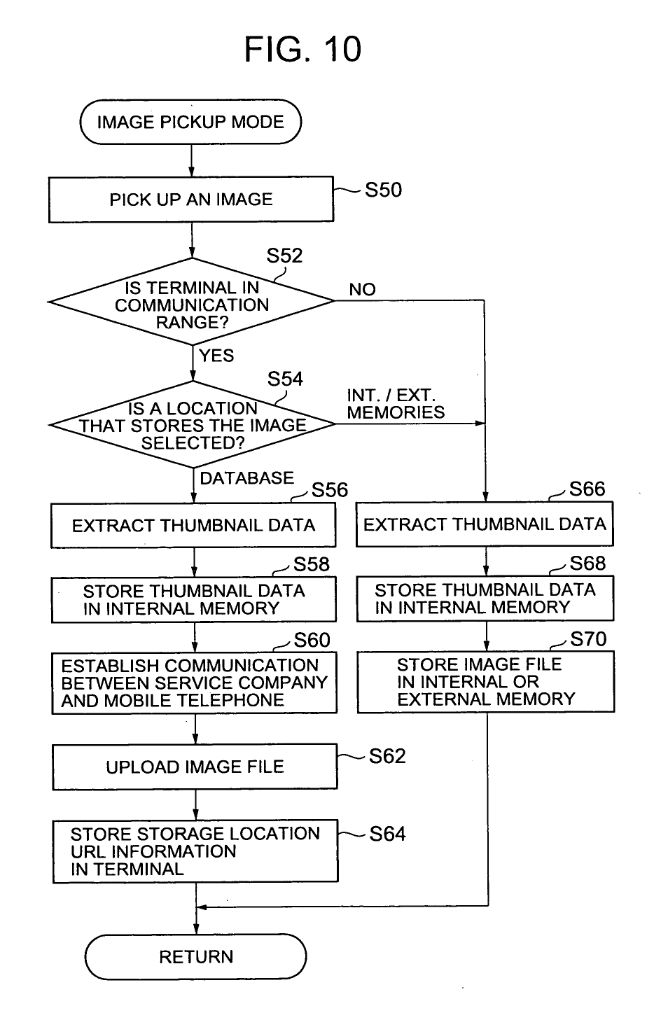

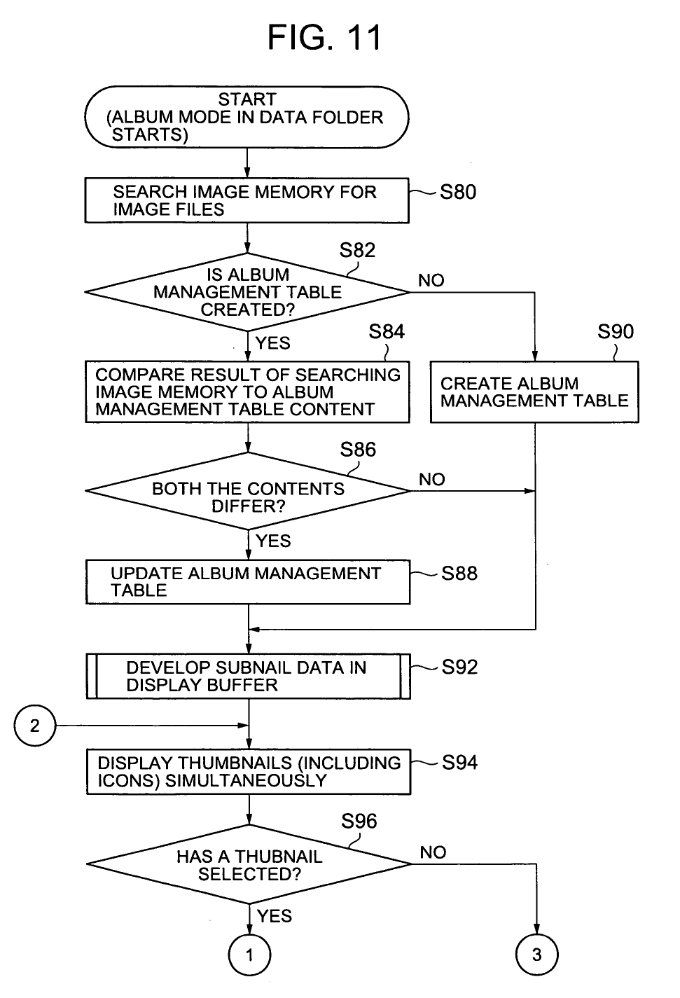

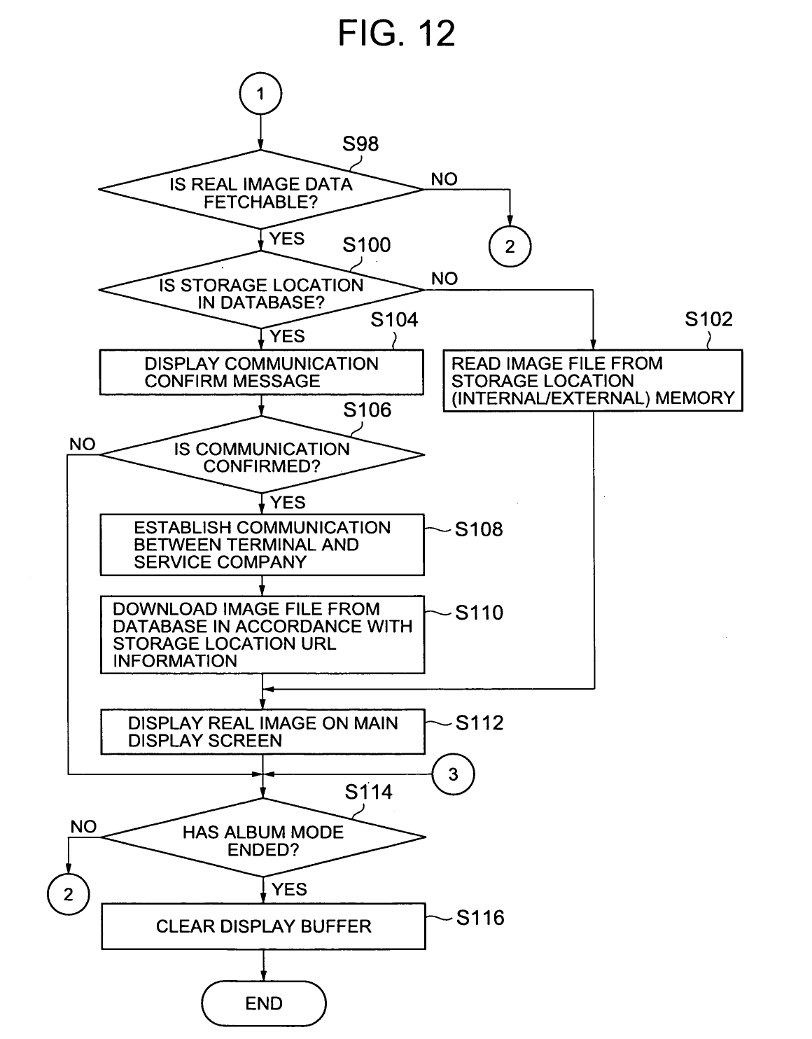

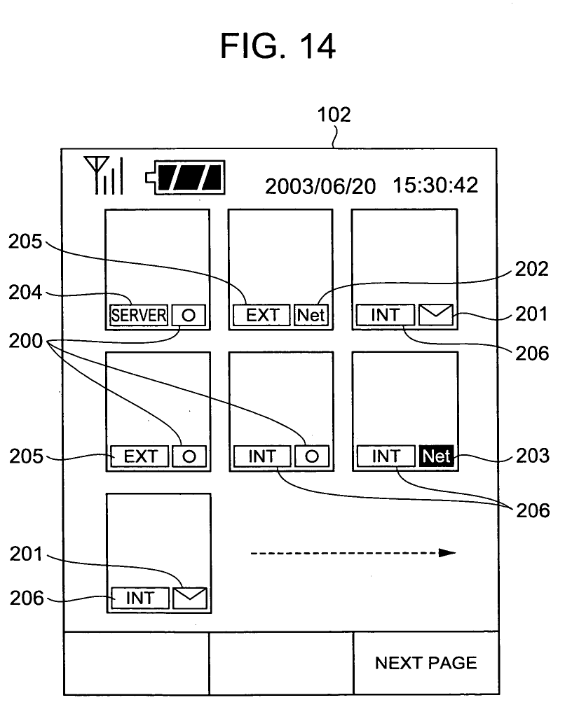

Operation of the second embodiment will be next described. FIG. 10 is a flowchart indicative of operation of the mobile telephone in the image pickup mode. FIGS. 11-13 are flowcharts indicative of the operation of the second embodiment in the album mode. FIGS. 14-16 schematically illustrates displays appearing on the main display unit 102 in the album mode.

(2-2-1) Image Pickup:

First, when the image pickup mode is selected by a predetermined manipulation and the shutter key (decision key 107) is depressed, the image pickup device 130 picks up as a color one an image focused by the image pickup lens 118. The DSP 129 encodes the image picked up by the image pickup device 130, thereby obtaining image data, compresses this data in accordance with an image compression/coding program stored in the program ROM 125, thereby producing an image file (S50). It is then determined whether or not the mobile terminal is in the communication range (S52). If the mobile terminal is in the communication range, the user is required to select one of the internal and external memories as well as the database 309 that provide a location at which the image file based on the picked-up image data is to be stored (S54).

When the user selects the database 309, thumbnail data of the image file is then extracted (S56) and stored in the internal memory (RAM 124) (S58). Communication is then established between the mobile telephone and the database service company 306 via the WWW 305 (S60), and the image file is uploaded at a predetermined storage location on the database 309 (S62). Then, URL information on the storage location, file name, attribute, storage date, size, and flags A and B, etc., of the image file are stored on the image file table 1241 in the mobile telephone RAM 124 (S64).

When the terminal is not in the communication range or one of the internal memory (RAM 124) and the external memory (external recording medium 145) is selected as the storage location, the thumbnail data of the image file based on the picked-up image data is extracted (S66) and stored in the internal memory (RAM 124). The file name, storage date and time, size, flags A and B, etc., are then stored on the image file table 1241 that is provided in the RAM 124 of the terminal (S68). Then, the image file is stored in the internal memory (RAM 124) or external memory (external recording medium 145) (S70).

(2-2-2) Album Display Operation:

First, when the album mode is selected by the user in the data folder, the RAM 124 is searched for image files (S80) and it is determined whether or not the album management table 1242 (FIG. 5) has been created (S82).

If the respective image files and the created album management table 1242 are found, each of the image files is then compared to the content of the album management table 1242 (S86). Then, it is determined whether or not both are different (S86).

If both are different, the content of the album management table 1242 is updated with a result of searching the RAM 124 (S88). More particularly, a display (row and column) position on the main display unit 102 for a prospective thumbnail for each of the image files different from the content of the album management table 1242 is determined, corresponding thumbnail data, if any, contained in that image file or corresponding thumbnail data created from a real image data contained in that image file if no original thumbnail data is contained in that image file, as indicated by the flag A, is used, thereby updating the content of album management table 1242. The thumbnail data corresponding to the thumbnail to be displayed is then developed in the display buffer in accordance with the updated content of the album management table 1242 (S92).

If both are the same in content, the thumbnail data to be displayed is developed in the display buffer in accordance with the content of the album management table 1242 (S92).

When it is known that no album management table 1242 has been created as the result of searching for the RAM 124, an album management table 1242 is created in accordance with the result of searching (S90). More particularly, display (row and column) positions of thumbnails for the image files stored in the RAM 124 on the main display 102 are sequentially determined in order of record number. The thumbnails are then created from the thumbnail data or real image data in accordance with the presence of the thumbnails indicated by the flag A, thereby creating an album management table 1242. Then, thumbnail data corresponding to the thumbnails to be displayed are developed in the display buffer in accordance with the content of the album management table 1242 (S92).

Creation of thumbnails for image files with copyright protection information is similar to that of the first embodiment. There is no problem with the development of the thumbnail data in the display buffer when the image files have been stored in the internal memory (RAM 124). However, an image file corresponding to the selected thumbnail data can be neither obtained nor displayed when the external memory (external recording medium 145) that has stored the image files is not set on the mobile telephone or when the mobile telephone is not within the communication range even when the image files have been stored in the database 309. In such a case, in this embodiment the thumbnail data in the image file is developed in the display buffer and displayed all in gray on the main display unit 102 such that the user can confirm at a glance that no image files can be obtained. The details of development of the thumbnail data in the display buffer will be described later in more detail.

As shown in FIG. 14, the respective thumbnails (simply shown by rectangles) based on the thumbnail data developed in the display buffer are displayed simultaneously on the main display unit 102 (S94). At this time, an icon indicative of an attribute of each image file (for example, a source from which the image file was obtained) is displayed at a predetermined position (for example, at a lower right end position in the illustrated example) of the displayed thumbnail. An icon 200 indicates “camera”; an icon 201 “received mail”; an icon 202 “downloaded (image without copyright protection information)”; an icon 203 “downloaded (image with copyright protection information)”. In addition, an icon is displayed at a predetermined position on each thumbnail (for example, at a lower left end position in the illustrated example), indicating a location where the image file data is stored. An icon 204 indicates that the image file data is stored in the “server” (database 309); an icon 205 “external memory (external recording medium 145)”; and an icon 206 “internal memory (RAM 124)”.

It is then determined whether or not any of the thumbnails (thumbnail) has been selected (S96). If it is not selected, it is determined whether or not the album mode has ended (S114). If the album mode has not ended, the control then returns to step S94 where the album mode continues. If the album mode has ended, the display buffer is cleared (S116). Thus, no thumbnail data/thumbnail of “graphic 02.jpg” with copyright protection information downloaded from the Internet remains.

If any particular thumbnail data is selected, it is then determined whether or not the corresponding image file can be fetched (S98). More particularly, if the thumbnail data displayed in gray is selected, (1) the corresponding image file is stored in the external memory or database 309, but the external memory is not set on the mobile telephone, (2) the mobile telephone is outside the area that the base station 300 covers or (3) the mobile telephone cannot be connected to the database service company 306, for example, due to congestion of the WWW 305. In this case, it is determined that the corresponding image file cannot be obtained. If the thumbnail displayed in gray is selected, the original image file cannot be obtained. Thus, for example, a message stating that fact is displayed and the control returns to step S94, where the album mode continues.

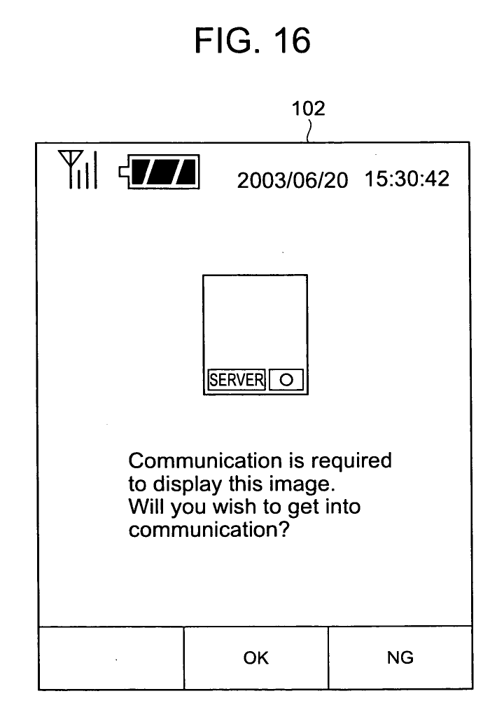

If the thumbnail data is not displayed in gray or the corresponding original image file is available, it is determined whether or not the location where the original image file is stored is in the database 309 (S100). If the storage location is in the internal memory (RAM 124) or the external memory (external recording medium 145), the image file is read out from the location where it is stored (S102) and displayed on the main display unit 102 (S112). Then, it is determined whether or not the album mode has ended (S114). If the album mode has not ended, the control returns to step S94 where the album mode continues. If the album mode has ended, the display buffer is then cleared (S116). If the storage location for the original image file corresponding to the selected thumbnail is in the database 309, a communication message to confirm whether or not the mobile telephone can be connected to the database service company 306 (for example, “communication is required to display this image. Will you wish to get into communication?”) is displayed on the main display unit 102, as shown in FIG. 16. If the user selects that no communication is required, it is then determined whether or not the album mode has ended without displaying an image based on the corresponding image file (S114). Unless the album mode has ended, the control then returns to step S94, where the album mode continues. If the album mode has ended, the display buffer is then cleared (S116).

If the user selects that the communication is required, communication is established between the user and the database service company 306 (S108). Then, the user refers to the image file table 1241 shown in FIG. 9, and downloads the image file from the database 309 in accordance with URL information on the location where the image file is stored (S110). The real image data of the downloaded image file is displayed on the main display unit 102 (S112). Then, it is determined whether or not the album mode has ended (S114). If the album mode has not ended, the control returns to step S94, where the album mode continues. If the album mode has ended, the display buffer is then cleared (S116).

(2-2-3) Development in Buffer:

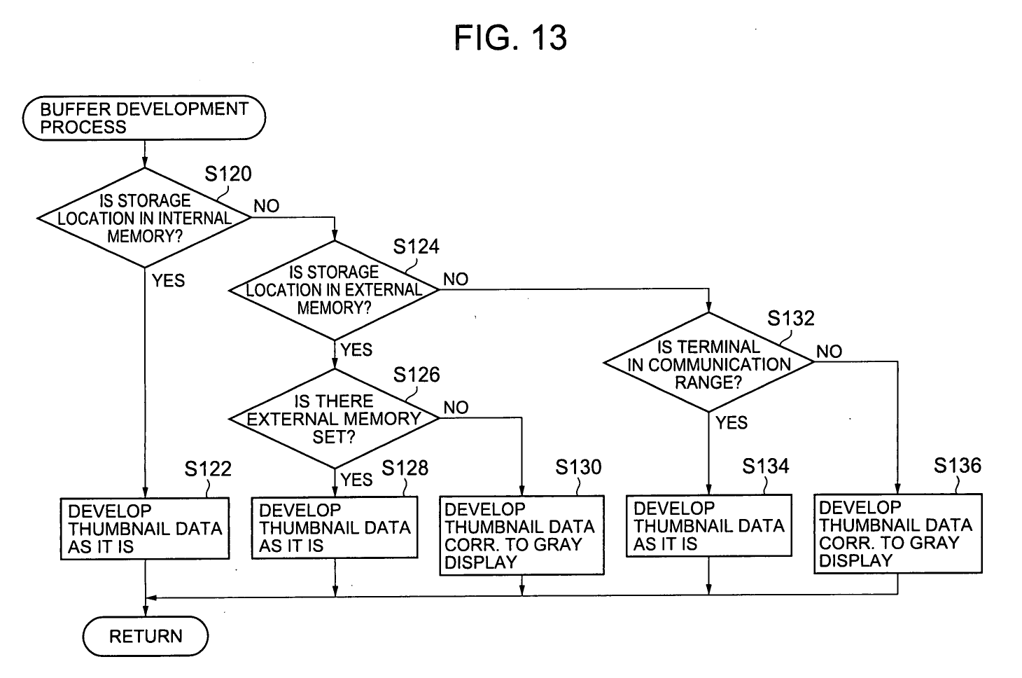

Then, development of the thumbnail data in the display buffer will be described in more detail with reference to FIG. 13. In this process, first, it is determined whether or not the location where the image file corresponding to the thumbnail data is stored is in the internal memory (RAM 124) (S120). If the storage location is in the internal memory, the thumbnail data is directly displayed on the display buffer (S122). In this case, thumbnails based on the thumbnail data is displayed as usual on the main display unit 102.

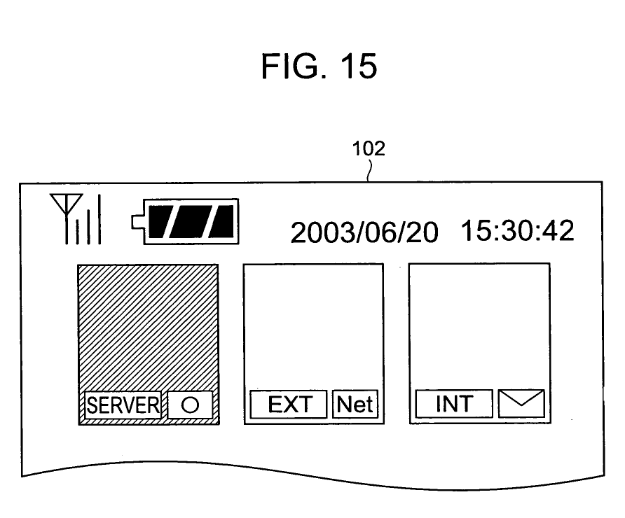

If the storage location of the corresponding image file is not in the internal memory, it is then determined whether or not it is in the external memory (external recording medium 145)(S124). If it is in the external memory, it is then determined whether or not the external memory is set (S126). If the external memory is set, the thumbnail data stored therein is developed as it is in the display buffer (S128). In this case, a thumbnail based on the thumbnail data is displayed as usual on the main display unit 102. If no external memory is set, the corresponding image file cannot be read out. Thus, the thumbnail data corresponding to gray display is developed (S130), and as shown in FIG. 15 the corresponding thumbnail is displayed in gray on the main display unit 102, as shown in FIG. 15.

If the location where the image file is stored neither in the internal memory nor in the external memory, or if it is in the database 309, it is then determined whether or not the terminal is in the communication range (S132). If the terminal is in the communication range, the thumbnail data is developed directly in the display buffer (S128). In this case, a corresponding thumbnail is displayed as usual on the main display unit 102. If the terminal is not in the communications range, the image file cannot be downloaded from the database 309. Thus, the thumbnail data corresponding to gray display is developed (S130), and as shown in FIG. 15 the corresponding thumbnail is displayed in gray on the main display unit 102.

As described above, the location where the image file as the source of thumbnail data is stored is in the external memory (external recording medium 145) or the database 309 connected to the WWW 305, it is checked to see whether or not the external memory is set or the terminal is in the communication range. If the corresponding image file cannot be obtained, the thumbnail data is displayed in gray. Thus, whether or not the original image file can be displayed can be confirmed at a glance.

While in the embodiment the thumbnail data (thumbnails) created from the picked-up image files and of the image files downloaded, for example from the Internet, are displayed simultaneously in a mixed state such that they can be confirmed at a glance, both the thumbnail data (thumbnails) can be displayed in a discriminating manner alternately in units of a page such that they can be discriminated at a glance. Alternatively, the thumbnail data created from the picked-up and downloaded image files stored in different storage devices may be simultaneously displayed in a discriminating manner alternately in units of a page for each storage device or location.

While in the embodiment the sources of the thumbnail data (thumbnails) picked up by the image pickup device and downloaded from the Internet are simultaneously displayed on the main display unit in such a manner that their sources can be discriminated by their respective icons, their frames may be displayed in different colors for discriminating purposes. Similarly, while when the thumbnails and corresponding icons are displayed simultaneously in a mixed state the thumbnails, whose original images cannot be obtained from the locations where they are stored (for example, when the mobile telephone is outside the communication range or no external recording medium is set), are displayed in gray, the frames of such respective thumbnails may be instead displayed in different colors for discriminating purposes.

While in the embodiment the application of the present invention to the mobile telephones with a camera has been described, the present invention is not limited to that case. For example, the present invention may be applicable to digital cameras, PDAs, and network household appliances that have the functions of wireless communication, connection to a network such as other LANs or reception of terrestrial digital broadcasts, and display of images acquired using such functions.

While the present invention has been described with reference to the still image files, it may be applicable to moving image files compressed in a MPEG form. More particularly, for moving image files obtained by the image pickup device (CCD) 130, any one selected from a plurality of I-frame image data produced when the moving image file was created may be stored as thumbnail data. For a moving image file with copyright protection information downloaded, only a head frame of the moving image file is extracted when the album mode starts, thereby producing thumbnail data. Then the thumbnail data of the moving image file with copyright protection information may be cleared when the album mode has ended.

Various modifications and changes may be made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application Nos. 2003-297768 filed on Aug. 21, 2003 and 2004-053684 filed on Feb. 27, 2004 and including specification, summary and claims, and drawings. The disclosure of the above Japanese patent application is incorporated herein by reference in its entirety.

1. An electronic apparatus comprising:
an image pickup device;
a first thumbnail-creating unit that creates a thumbnail of an image picked up by the image pickup device;
a storage unit that stores in a predetermined file form the thumbnail created by the first thumbnail creating unit along with the image picked up by the image pickup device;
a communication unit;
a reception unit that receives an image file from a network outside the electronic apparatus, using the communication unit;
a storage control unit that stores in the storage unit the image file received from the reception unit;
a display unit;
a command unit that gives the display unit a command to simultaneously display the images stored in the storage unit;
a second thumbnail creating unit, responsive to the command from the command unit, for creating a thumbnail from the image file received by the reception unit; and
a first display control unit that simultaneously displays the thumbnails created by the first and second thumbnail creating units on the display unit.

2. The electronic apparatus of claim 1, further comprising:
a temporary storage unit that temporarily stores the thumbnail created by the second thumbnail creating unit; and
a clearing unit, responsive to the command unit withdrawing the command, for clearing the thumbnails stored in the temporary storage unit.

3. The electronic apparatus of claim 2, further comprising:
a determining unit that determines whether or not copyright protection information is annexed to the received image file; and wherein:
the clearing unit clears the thumbnails stored in the temporary storage unit and determined by the determining unit as having annexed copyright protection information.

4. The electronic apparatus of claim 1, wherein the first display control unit simultaneously displays the thumbnails of the picked-up images and of the received image file on the display unit in a discriminating manner.

5. The electronic apparatus of claim 1, wherein the first display control unit simultaneously displays the thumbnails of the picked-up images and of the received image file in a mixed state on the display unit.

6. The electronic apparatus of claim 1, wherein the first display control unit simultaneously displays the thumbnails of the picked-up images and of the received image file in a mixed state on the display unit in a discriminating manner.

7. The electronic apparatus of claim 1, further comprising:
a storage location determining unit that determines whether or not original images for the thumbnails stored in the storage unit are stored in a database provided on a network outside the electronic apparatus; and
a second display control unit, responsive to the command unit giving the command, for simultaneously displaying the thumbnails on the display unit in a mixed state such that a result of determination by the storage location determining unit is reflected on the displayed thumbnails.

8. The electronic apparatus of claim 7, further comprising:
a transmission unit that transmits an image file based on the image picked up by the image pickup device to the database for storing purposes.

9. The electronic apparatus of claim 7, wherein the reception unit comprises a receiving unit that receives an image file wirelessly from the database; and further comprising:
a monitor unit that monitors a reception state of the receiving unit; and
a third display control unit, responsive to the command unit giving the command, for causing the display unit to simultaneously display the thumbnails in a mixed state such that a result of monitoring by the monitor unit is reflected on the displayed thumbnails.

10. The electronic apparatus of claim 1, further comprising:
a removable external recording medium set on the electronic apparatus;
a storage control unit that stores on the external recording medium an image file based on the image picked up by the image pickup device;
a setting determining unit that determines whether or not the external recording medium is set on the electronic apparatus; and
a fourth display control unit, responsive to the command unit giving the command, for simultaneously displaying the thumbnails on the display unit in a mixed state such that a result of determination by the setting determining means is reflected on the displayed thumbnails.

11. An image display method in an electronic apparatus comprising an image pickup device, a communications unit and a display unit, the method comprising the steps of creating a thumbnail of an image picked up by the image pickup unit;
storing in a memory in a predetermined file form the thumbnail created in the thumbnail creating step along with the image picked up by the image pickup device;
receiving an image file containing an image from a network outside the electronic apparatus, using the communication unit;
storing in the memory the image file received in the receiving step;
giving the display unit a command to simultaneously display the images stored in the memory;
responsive to the command, creating a thumbnail of the image contained in the image file received in the receiving step; and
simultaneously displaying on the display unit the thumbnails created in both the creating steps.

12. The electronic method of claim 11, further comprising the steps of:
determining whether or not copyright protection information is annexed to the image file received in the receiving step; and
responsive to the given command being withdrawn, clearing the thumbnail of the thumbnail file that was determined in the determining step as having annexed copyright protection information.

13. The image display method of claim 11, further comprising:
determining whether or not an original image from which the thumbnail stored in the memory in the storing step is derived is stored in a database provided on a network outside the electronic apparatus; and wherein:
responsive to the given command, the simultaneously displaying step performs simultaneously displaying the thumbnails on the display unit in a mixed state such that a result of determination in the storage location determining step is reflected on the displayed thumbnails.

14. The image display method of claim 13, wherein the receiving step comprises receiving an image file wirelessly from the database and monitoring a reception state of the communications unit; and
responsive to the given command, the simultaneously displaying step performs simultaneously displaying the thumbnails in a mixed state on the display unit such that a result of monitoring in the monitoring step is reflected on the displayed thumbnails.

15. The image display method of claim 11, further comprising the steps of:
storing the picked-up image on a removable external recording medium set on the electronic apparatus;
determining whether or not the external recording medium is set on the electronic apparatus; and wherein:
responsive to the given command, the displaying step performs simultaneously displaying the thumbnails on the display unit in a mixed state such that a result of determination in the determining step is reflected on the displayed thumbnails.

16. An image display program for causing a computer with an image pickup device, a communications unit and a display unit to perform the functions of:
creating a thumbnail of an image picked up by the image pickup unit;
storing in a memory in a predetermined file form the thumbnail created by the thumbnail creating function along with the image picked up by the image pickup device;
receiving an image file containing an image from a network outside the computer, using the communication unit;
storing the image file received by the receiving function in the memory;
giving the display unit a command to simultaneously display the images stored in the memory;
responsive to the command, creating a thumbnail of the image contained in the image file received by the receiving function; and
simultaneously displaying on the display unit the thumbnails created by both the creating functions.

17. The image display program of claim 16, further causing the computer to perform the functions of:
determining whether or not copyright protection information is annexed to the image file received by the receiving function; and
responsive to the given command being withdrawn, clearing the thumbnail of the thumbnail file that was determined by the determining function as having annexed copyright protection information.

18. The image display program of claim 16, further causing the computer to perform the functions of:
determining whether or not an original image from which the thumbnail stored in the memory by the storing function is derived is stored in a database provided on a network outside the computer; and wherein:
responsive to the given command, the simultaneously displaying function performs simultaneously displaying the thumbnails on the display unit in a mixed state such that a result of determination in the storage location determining function is reflected on the displayed thumbnails.

19. The image display program of claim 18, wherein the receiving step comprises receiving an image file wirelessly from the database and monitoring a reception state of the communications unit; and
responsive to the given command, the simultaneously displaying step performs simultaneously displaying the thumbnails in a mixed state on the display unit such that a result of monitoring in the monitoring step is reflected on the displayed thumbnails.

20. The image display program of claim 11, further causing the computer to perform the functions of:
storing the picked-up image on a removable external recording medium set on the computer;
determining whether or not the external recording medium is set on the computer; and wherein:
responsive to the given command, the displaying function performs simultaneously displaying the thumbnails on the display unit in a mixed state such that a result of determination by the determining function is reflected on the displayed thumbnails.
